(19) United States
(12) Patent Application Publication
(10) Pub. No.: US 2017/0188583 A1
(43) Pub. Date: Jul. 6, 2017

(54) BIOCIDAL COMPOSITION FOR CLEANING HARD SURFACES CONTAMINATED WITH PROTEINACEOUS AND FATTY RESIDUES

(71) Applicant: BROMINE COMPOUNDS LTD., Beer Sheva (IL)

(72) Inventors: Shlomo ANTEBI, Haifa (IL); David FELDMAN, Haifa (IL)

(73) Assignee: Bromine compounds Ltd.

(21) Appl. No.: 15/308,747

(22) PCT Filed: May 5, 2015
(86) PCT No.: PCT/IL2015/050470

§ 371 Date: Nov. 3, 2016

Related U.S. Application Data
(60) Provisional application No. 61/993,478, filed on May 15, 2014.

(51) Int. Cl. A01N 59/00; A23B 4/24; B08B 3/08; A01N 25/22; C11D 3/48

(52) U.S. Cl. CPC A01N 59/00; A01N 25/22; C11D 3/48; B08B 3/08; A23B 4/24

(57) ABSTRACT

This invention provides a cleaning and biocidal composition containing stabilized active bromine for treating hard surfaces contaminated with proteinaceous and fatty residues.

### FIELD OF THE INVENTION

The present invention relates to a composition for cleaning surfaces in the environment comprising proteinaceous and fatty residues.

### BACKGROUND OF THE INVENTION

The work environment contaminated with protein and fat residues, such as for example hard surfaces employed in meat industry, is inherently rich on materials which serve as nutrients for most organisms, and importantly for dangerous food pathogens. Current manufacturing procedures, for example the procedures employed in food or meat industry, must provide safe final food products, even though the procedures consist of complex stages, for example including also raising and transporting animals, slaughtering and processing the carcasses, and finalizing the production and storing foodstuffs. Pathogenic bacteria may originate from live animals or may enter the system at any of the mentioned stages, presenting a threat to the producers and consumers of the foodstuff, in the form of active microorganism forms or spores. Effective means for cleaning and disinfection are required to restrict contamination, prevent cross-contamination, and minimize the danger of infection. The hard surfaces in the work environment, whether in direct contact with the food and meat products or not, represent an immense cultivation space for growing microorganisms; the surfaces may be comprised in transport equipment, processing equipment, and process and storage premises. The microorganisms or their dormant forms may be attached directly on the hard surface, or they may be bound on or in soil covering said surface. Some bacteria produce substances leading to their strong adhesion to the surface and to the formation of biofilm.

The cleaning step which removes dirt and organic substances such as fat and protein particles from walls, floors, equipment and other surfaces contaminated during meat production is supposed to remove more than 90% microbes; however, even small residues of live microorganisms, still presenting a serious problem, must be neutralized, which may be effected by heat or disinfectants. It is known that sterility cannot be practically achieved in meat manufacture, but complete removal of pathogens is necessary.

Many biocidal compositions that are commercially available or that have been described include strong oxidants, such as active halogen solutions. The most frequently used biocidal means comprise hypochlorous acid and its salts. It is a known problem that the efficient biocides have low stability and often must be prepared shortly before their application, making the work with them clumsy. Quick losses of the active ingredients result in higher process costs, while also dangerously increasing the health risks in case of incomplete disinfection. WO 2012/123695 reviews some problems associated with low stability of hypochlorite solutions, and provides hypochlorite compositions stabilized with acids, such as phosphoric or citric, having an acidic to neutral pH. US 2011/0300080 describes a two-part disinfecting composition for disinfecting a hard surface, comprising a chlorite, an acid and an olefin, the acid and olefin stabilizing the chlorite and adjusting the pH to acidic. Of other active halogens, bromine is sometimes used, but also hypobromite solutions are usually not sufficiently stable for practical applications. US 2011/0200685 reviews some problems associated with low stability of hypobromite solutions, and provides hypobromite compositions by oxidizing bromides with hypochlorites, the compositions having a pH near to neutral and being stable for hours. The existing compositions are often too complex and cannot be prepared by a simple method as one stock solution for long storage, ready to be later simply diluted and used for cleaning or biocidal application in the work environment, possibly including meat industry. It is an object of this invention to provide an efficient biocidal composition for practically long storage and for later use in cleaning, and possibly also disinfecting hard surfaces contaminated with proteins and fats, for example surfaces employed in meat industry.

It is another object of this invention to provide a composition for cleaning hard surfaces in the environment comprising fat and protein residues originating from sources selected from microbial, animal, or human.

It is further an object of the invention to provide a stable cleaning and biocidal composition for treating hard surfaces employed in industry or agriculture, surfaces in contact with waste waters, and contaminated surfaces in public facilities including medical care facilities, like hospitals, contaminated with pathogenic viruses, bacteria, and fungi.

It is also an object of the invention to provide a composition based on aqueous active bromine, which would keep its cleaning and biocidal efficiency even after prolonged storage, and at high alkaline pH, and which would be ready for use, after needed dilution, in treating hard surfaces employed in food industry, particularly in meat production.

It is also a further object of the invention to provide a composition based on stabilized active bromine for treating hard surfaces employed in meat industry, said treatment comprising removal of protein and fat residues, and neutralization of pathogenic organisms.

It is still another object of the invention to provide a biocidal aqueous composition, stable on storage and active after dilution, for use in treating surfaces exposed to microbial contamination inside food industry and particularly meat industry premises, or for treating liquids in contact with said surfaces.

It is a still further object of the invention to provide a method for manufacturing a stable stock composition for use in cleaning hard surfaces in meat production, and for use in neutralizing microbial contaminations in meat processing premises.

Other objects and advantages of present invention will appear as description proceeds.

### SUMMARY OF THE INVENTION

This invention provides a composition for cleaning hard surfaces from proteinaceous and fat residues, comprising stabilized active bromine and a surface active agent, where said stabilized active bromine has a half-life at ambient temperature of at least six months. The composition of the invention comprises active bromine at a concentration of up to about 14%, which corresponds to about 6% when expressed as active chlorine. The composition preferably comprises sulfamate as a stabilizer of said active bromine. The surface active agent may comprise several surfactants, preferably up to six surfactants. The unit “%” relates to “wt %” if not defined otherwise throughout the whole text.

In a preferred embodiment, the composition of the invention is a biocidal aqueous solution for cleaning or disinfecting hard surfaces in meat industry, stable on storage, comprising i) sodium hypobromite (NaOBr) in an amount of up to about 10%; ii) sodium sulfamate (NaSO₃HN₂) in a weight excess over said NaOBr of about 10%; iii) sodium hydroxide (NaOH) in an amount of from 55 to 20%; iv) sodium chloride (NaCl) in an amount of about 1% to about 4%; and v) surfactants in an amount of from 4% to 12%; the composition being an aqueous, biocidal solution for cleaning hard surfaces in meat industry, stable on storage. The composition is highly efficient in cleaning hard surfaces from proteinaceous and fat residues, and exhibits strong biocidal properties at alkaline pH even after prolonged storage at ambient temperature. Said value of about 10% NaOBr corresponds to about 13.5% of active bromine, and to about 5.9% of active halogen when expressed as active chlorine. In another preferred embodiment, the composition of the invention is a biocidal aqueous solution for cleaning or disinfecting hard surfaces contaminated with proteinaceous and/or fatty residues, including surfaces employed in industry or agriculture, surfaces in contact with waste waters, and surfaces employed in public health facilities, the solution being stable on storage and comprising i) sodium hypobromite (NaOBr) in an amount of up to about 10%; ii) sodium sulfamate (NaSO₃HN₂) in a weight excess over said NaOBr of about 10%; iii) sodium hydroxide (NaOH) in an amount of from 55 to 20%; iv) sodium chloride (NaCl) in an amount of about 1% to about 4%; and v) surfactants in an amount of from 4% to 12%.

In a preferred embodiment of the invention, the composition comprises at least one surfactant compatible with alkali and oxidative environment; for example one to six surfactants having the total concentration between 4% and 12% are included. In one embodiment, the composition comprises an anionic polymer dispersant; an example is an acrylate-based dispersant, such as, for example, Alcosperse 602N of Akzo Nobel or Cambrex N45 of Cambrian Solutions Inc.

The biocidal composition of the invention may comprise NaOBr in an amount of from 1% to 10%, such as about 5%; NaOH in an amount of from 5% to about 15; and surfactants in an amount of from 4 to 12, such as about 5 to 10%, for example about 7%. In one embodiment, the biocidal composition of the invention comprises NaOBr in an amount of from 5% to 10%; NaSO₃NH₂ in amount of from 5.5% to 11%; NaOH in an amount of about 15; NaCl in an amount of 1.5 to 3%; and surfactants in an amount of 6% to 10%. In some embodiments, the biocidal composition of the invention exhibits a content of active bromine of at least 50,000 ppm even after prolonged storage at ambient temperature for 12 months or more. Said weight excess of sodium sulfamate over said NaOBr may be between 5% and 13% of the NaOBr weight, so that the concentration of NaSO₃NH₂ in the biocidal composition having from 5 to 10% NaOBr will usually be between about 5.2% and about 11.3%. The biocidal composition of the invention preferably keeps its biocidal efficiency even after prolonged storage, and it is ready-to-use formulation, eventually after dilution, for treating hard surfaces employed in food industry, particularly in meat industry. The biocidal composition of the invention is active against viruses, bacteria, fungi, and spores thereof, even after dilution, and is advantageously used also in treating other than hard surfaces exposed to microbial contamination inside food industry premises, or for treating liquids in contact with said surfaces. The biocidal composition of the invention is used to reduce contamination, prevent cross-contamination, and minimize the danger of infection.

The biocidal composition according to the invention may contain active bromine at a concentration of up to about 13.5%, for example up to 12%, or up to 10%, or up to 8%, or up to 6%. The biocidal composition according to the invention may contain active halogen of up to about 6% when expressed as active chlorine, for example up to 5%, or up to 4, or up to 3%, or up to 2%. Usually, the biocidal composition of the invention comprises active bromine of between about 3.5% Br₂ and about 11.5% Br₂, which corresponds to an active halogen value expressed as active chlorine of between about 1.5% Cl₂ and about 5% Cl₂.

In one embodiment of the invention, the composition for cleaning the surfaces in meat industry is prepared from a tablet which incorporates to water the required components, including sodium NaOBr, NaSO₃NH₂, NaOH, NaCl and surfactants. The invention aims at a tablet for preparing an aqueous composition for cleaning hard surfaces from proteinaceous and fat residues, the tablet comprising stabilized active bromine and a surface active agent, wherein said stabilized active bromine in said aqueous composition has a half-life at ambient temperature of at least six months, and wherein said stabilized active bromine in said tablet has a half-life at ambient temperature of at least 12 months, such as at least 18 months, such as at least 24 months, such as at least 30 months, such as at least 36 months.

The invention aims at a method of cleaning hard surfaces in meat industry, comprising i) providing a biocidal composition comprising stabilized active bromine and a surface active agent, where said stabilized active bromine has a half-life at ambient temperature of at least six months, storing said composition and optionally diluting it with water; ii) contacting said hard surface with said composition for a desired time; iii) optionally mechanically and/or thermally treating said surface; and iv) washing said surfaces with water or with said composition being optionally still more diluted. The method may comprise treating the surface with hot water or steam at various stages. Said step of providing a biocidal solution may comprise mixing NaSO₃NH₂, NaOH, NaCl, surfactants, a source of NaOBr, and water. Said step of providing a biocidal solution may comprise dissolution in water of a tablet comprising NaOBr, NaSO₃NH₂, NaOH, NaCl and surfactants.

Stock cleaning and biocide composition of the invention may be diluted to provide working solutions exhibiting the content of active bromine of, for example, up to 100,000 ppm, or up to 50,000 ppm, or up to 10,000 ppm, or up to 5000 ppm, or up to 4000 ppm, or up to 3000 ppm, or up to 2000 ppm, or up to 1000 ppm, or up to 500 ppm, or up to 400 ppm, or up to 300 ppm, or up to 200 ppm, or up to 100 ppm, or up to 50 ppm, or up to 40 ppm, or up to 30 ppm, or up to 20 ppm, or up to 10 ppm, or up to 5 ppm, or up to 4 ppm, or up to 3 ppm, or up to 2 ppm, or up to 1 ppm, or less than 1 ppm, for example more than 0.1 ppm, or more than 0.2 ppm, or more than 0.3 ppm, or more than 0.4 ppm, or more than 0.5 ppm. Said treated surfaces are comprised in equipment or in premises employed in raising and transporting animals, in slaughtering animals and processing the carcasses, and in processing and storing meat and meat products. Said surfaces may comprise vehicles, trolleys, machines, conveyor belts, tools, and walls, floors and ceilings of processing rooms, refrigeration rooms, and storage rooms. Said surfaces may also comprise knives, cutters, saws, mixers, gloves, and aprons. The method of the invention comprises treating surfaces exposed to proteinaceous and fat contaminants and to microbial contaminations inside food industry premises. The method of the invention also comprises treating surfaces exposed to microbial contaminations inside food industry premises, including carcasses, meat blocks, meat products, and packaging materials compatible with the biocide. The method of the invention may further comprise treating water before or after its use in washing said surfaces, comprising admixing to said water said biocidal solution. The method of claim the invention preferably comprises cleaning and disinfecting hard surfaces in the environment comprising residues of fats, proteins, saccharides, mixtures thereof, and other organic materials. The method of the invention may comprise reducing contamination, preventing cross-contamination, and minimizing the danger of infection. The invention relates to a cleaner and biocide which is highly efficient for treating hard surfaces in food industry, particularly meat production. The cleaner and the method according to the present invention are effective in neutralizing a contamination comprising pathogenic viruses, bacteria, and fungi. The method of the invention may comprise storing the biocide of the invention before its use for prolonged periods one month or more. The cleaner and biocide compositions of the invention may be stored, in some embodiments, for at least 4 months and up to 12 months or more, such as for at least 5 months, such as for at least 6 months, such as for at least 7 months, such as for at least 8 months, such as for at least 9 months, such as for at least 10 months, such as for at least 11 months, such as for at least 12 months, such as for more than 12 months while keeping its cleaning and biocidal properties. A skilled person will appreciate that when active bromine in a biocidal composition of the invention has a half-life of 6 months at 35° C., it will have a half-life of roughly 1 year at 25° C. and roughly 2 years at 15° C.

The invention provides a process for manufacturing a superior biocidal aqueous composition for efficient cleaning hard surfaces in meat industry, stable on prolonged storage, comprising i) providing an aqueous composition comprising NaOBr in an amount of from 1% to 10% and NaSO₃NH₂ in a weight excess over said NaOBr of about 10% of the NaOBr weight; ii) mixing said NaOBr composition with an amount of NaOH, such as aqueous NaOH; and iii) admixing to said mixture of NaOBr and NaOH an amount of surfactant; wherein said amounts of NaOH and surfactant are such that the final NaOH concentration is from about 5% to about 15%, and the final surfactant concentration is from about 4% to about 12%. Said solution of NaOBr and NaSO₃NH₂ usually further comprises NaCl, preferably to provide about 1% to 3% in the final formulation, wherein said surfactant may comprise one or more different materials, and wherein said admixing steps are preferably performed at ambient temperature or a temperature lower than ambient. In one embodiment, the composition for efficient cleaning hard surfaces in meat industry is prepared by dissolution of a tablet in water, wherein the tablet comprises NaOBr, NaSO₃NH₂, NaOH, NaCl and surfactants.

The invention relates to a tablet for the preparation of an aqueous composition for cleaning and disinfecting hard surfaces contaminated with proteinaceous and fat residues, the tablet comprising stabilized active bromine and a surface active agent, the preparation of said composition comprising simple dissolution of the tablet in water, where said stabilized active bromine has a half-life at ambient temperature of at least six months in said aqueous composition and at least 12 months in said tablet.

### BRIEF DESCRIPTION OF THE DRAWINGS

The above and other characteristics and advantages of the invention will be more readily apparent through the following example, and with reference to the appended drawings, wherein:

FIG. 1. shows the decrease of active halogen with time in two biocidal compositions stored for 35 days at 25° C. or 35° C.; the first composition was prepared according to the invention and its active halogen is bromine (Formulation 1), the second composition is comparative and its active halogen is chlorine (Comparative Formulation 1); both compositions start at the same active halogen content of 4.1% as active chlorine (100%); the biocide according to the invention at 25° C. decreased to about 92% of the initial active halogen value (the highest curve, grey triangles), the biocide according to the invention at 35° C. decreased to about 80% of the initial active halogen value (the second curve, grey squares), the comparative biocide according to prior art at 25° C. decreased to about 71% of the initial active halogen value (the third curve, white triangles), the comparative biocide at 35° C. decreased to about 43% of the initial active halogen value (the lowest curve, black diamonds). As expected from chemical kinetics, the decrease is twice quicker at a temperature higher by 10° C.;

FIG. 2. shows the decrease of active halogen with time in two biocidal compositions stored for 30 days at 35° C.; the first composition was prepared according to the invention and its active halogen is bromine, the second composition is comparative and its active halogen is chlorine; both compositions start at the same active halogen content of 2.7% as active chlorine (100%); the biocide according to the invention decreased to about 85% of the initial active halogen value (the upper curve, circles), the comparative biocide according to prior art decreased to about 78% of the initial active halogen value (the lower curve, squares); and

FIG. 3. shows % sludge bacteria killed when employing either bromine-based Formulation 1 according to the invention (“Bromosol”) or chlorine-based Comparative Formulation 1 (“Hypo”), the contact times were either 0.5 or 3 hours (CT 0.5, CT 3), the active halogen concentrations were 2, 5, or 10 ppm; FIG. 3A relates to bacterial compositions comprising TOC of 10 ppm (total organic carbon is 10 ppm), FIG. 3B relates to TOC of 30 ppm, and FIG. 3C relates to TOC of 50 ppm.

### DETAILED DESCRIPTION OF THE INVENTION

A biocidal composition has now been developed, which combines high cleaning and biocidal efficiency in the environment of meat industry with superb storage stability. The composition comprises active bromine and has stronger biocidal effects than the composition comprising active chlorine of the same molar concentration and otherwise the same components, as was demonstrated in the Examples. By replacing active chlorine in cleaning compositions with active bromine, the storage stability has been enhanced. The active bromine may have a concentration of up to 13.5%. The low-stability problems known in prior art have been overcome by stabilizing the active bromine in a simple mixture comprising sodium hypobromite, sodium sulfamate, sodium hydroxide, sodium chloride, and surfactant(s). The composition is very efficient in treating hard surfaces comprising proteinaceous and fat residues; hydroxide assists in solubilizing fats, sodium chloride in solubilizing proteins, and the surfactant(s) enhance these activities; each component of this simple composition seems to contribute both to the cleaning power and to the storage stability of the composition. The instant combination of components takes advantage of the ability of bromine to keep its biocidal properties also under alkali conditions, enabling to combine strong biocidal effects of active halogen with solubilizing power of the surfactants and high pH. The active bromine under these conditions has a potential to neutralize all dangerous pathogens met in the food industry and particularly meat industry, including viruses, bacteria, protozoa, and fungi.

The cleaning and biocidal composition of the invention may be manufactured in any needed quantities in advance, it can be stored for practically any needed period before starting the treatment, providing a robust system for pest control, and particularly microbial control, in meat industry. The storage stability of the instant stock compositions, as high as half a year or more, is high in comparison with published values of similar biocide mixtures and can be still more enhanced by lowering storage temperatures, as demonstrated in the Examples. The biocide composition of the invention may be universally and flexibly used during the whole process of meat production, from handling the animals to final processing and storing the meat foodstuffs, in various dilutions which will enable to obtain huge solution volumes from relatively compact stock compositions. In some embodiments, the cleaning and biocidal composition, manufactured in a simple process, stored, and transported to the site of application, will comprise up to 130,000 ppm of active bromine—it is known that in some applications mere 0.1 ppm will be sufficiently active.

The transporting, processing, refrigerating, and storing lines in the meat industry may advantageously employ the cleaner and biocide of the invention, for treating the surface of tools, equipment, facilities, and premises, which include possible treatment of work tables, room walls, windows, ceilings, and floors. The surfaces, for example, may comprise livestock vehicles and receiving area, but also packaging and storage area. The invention aims at treating hard surfaces soiled with proteins and fats, in order to remove proteinaceous and other organic residues, and in order to prevent and/or neutralize the microbial contamination on said surfaces. The invention also aims at treating hard surfaces which may come to contact with meat products directly or via air or liquids, in order to prevent microbial contamination in said products. The hard surface may include any material used in the field such as, for example, metals, ceramic, stone, wood, glass, and synthetic polymers. However, the cleaner and biocide of the invention will advantageously be utilized also for treating other surfaces possibly exposed to contaminations during the meat production, including flexible and soft surfaces, such as plastics. The biocide may be also utilized for treating fluids; aqueous liquids may be treated by admixing the biocide concentrate; air may be treated by being led through the biocidal composition, optionally absorbed in a filtration medium, or by fogging the biocide into it.

The experts will know the necessary concentrations of the components in the cleaning and biocidal composition, and/or the necessary dilution of the composition; said concentrations will be affected by the requirements and goals of the treatment process which should sufficiently clean certain surface from protein and fat residues. If the biocidal activity should be ensured, the necessary concentrations and dilutions will be estimated according to the target organism in simple microbiological efficacy tests. The target organism may include known viruses, bacteria, protozoa, fungi, but also higher organisms like worms. The composition of the invention will be used in the meat industry for cleaning, disinfection, and sanitation, wherein said cleaning should mainly remove proteinaceous and fat residues, said disinfecting should neutralize the pathogenic microrganisms, and said sanitation should rid the treated surface of eventual higher organisms, such as worms and insects. To give an example, the known bacteria may comprise genera Escherichia, Campylobacter, Salmonella, Aeromonas, Shigella, Staphylococcus, Bacillus, and many other. In various applications, the method of the invention will be applied for cleaning and disinfection of mobile equipment, fixed equipment, parts of buildings, etc. The biocide according to the invention may be employed sequentially in more dilutions for treating the same surface. Washings of the treated surface may be accompanied, according to the need, with simultaneous or consequent mechanical treatment, like scrubbing, agitation or shaking, sonication, etc., and/or thermal treatment, like high pressure hot water or steam jetting, etc. The biocidal liquid may be applied by pouring, dipping, spraying, fogging, jetting, etc.

The treatment with the cleaning and/or biocidal composition of the invention will, in some embodiments, reduce microbial contamination, prevent the microbial multiplication, neutralize spores, disinfect the surfaces and the area, prevent infection, or prevent cross-contamination from one area to other, or from one product to other; the treatment will, in other embodiments, reduce, eliminate or prevent biofouling, or it will break a biofilm; in some embodiments, the treatment will comprise washing, or cleaning a surface. In a preferred embodiment of the invention, the composition as prepared and optionally stored for prolonged periods, will be applied on the surfaces to be cleaned after dilution. In various applications, the end use dilution with water will be 0.5 to 5 v/v %. The invention is directed to cleaning i) surfaces employed in or associated with industrial and agricultural facilities, particularly comprising food production, ii) surfaces employed in or associated with public service facilities, particularly comprising public health and medical care facilities, and iii) surfaces in contact with waste waters or associated with waste water treatment.

The experts will choose suitable concentrations and types of surfactants according to the planned application. For example, in some applications the cleaning composition will be employed in a circulation-in-place (CIP) application, in which the liquid cleaning composition is circulated throughout the system following the same circuit that food ingredients would take during processing. The circulation can take anywhere from a few minutes to half an hour or as long as the operator requires so the contact time is not a concern. In such a system, the turbulent flow of surfactant solution may create unwanted amount of foam. The end dilution of the composition may be, for example from 0.5 to 1.0 v/v %. In other applications, the cleaning composition is employed in open plant cleaning (OPC), sometimes including vertical surfaces, and as a certain minimal contact time for the surfactant to act on the soil is required, viscosity modifiers are added to prolong the time the surfactant remains on the surface to more than a few seconds, in order to enhance soil removal. These agents allow the surfaces to remain wet with the composition for a minimal period and can then be rinsed off with potable water. Gel and/or foam applications may be involved in the OPC; the end dilution may be from 2.5 to 5.0 v/v %; for example, a dilution of 3 v/v % may be used for foam applications, and 4.5 v/v % for gel applications.

An example of a cleaning composition according to the invention for CIP application is a stabilized active bromine solution comprising 6% of NaOBr, 6.6% of NaSO₃NH₂, 15% of NaOH, and 8% of neutralized sodium polyacrylic polymer, such as Alcosperse 602N as a surfactant. This CIP cleaner is designed for circulation cleaning even at elevated temperatures, when needed. The surfactant is stable in highly alkaline solutions, and is not affected by the available active halogen.

An example of a cleaning composition according to the invention for OPC application is a stabilized active bromine solution comprising 2.5% of NaOBr, 2.7% of NaSO₃NH₂, 6% of NaOH, and 6% of surfactants composed of six materials comprising sodium xylene sulfonate, dodecylbenzene sulfonic acid (Biosoft S101), caprylic-capric fatty acid (Emery 658), sodium tridecyl ether sulfate (Cedepal TD 403), phosphono-carboxylic acid (Belsperse 164), and tetradecyl dimethyl amine oxide (Aromox 14D-W970). The application temperature of the solution usually occurs at ambient or below ambient temperatures, so that the saponification of fatty soils is reduced. The surfactants are relatively stable. Caprylic and capric acids are converted to their respective soaps, more soluble than other soaps in hard water, suitable for use in products where a longer retention time is required. Tetradecyl amine oxide enhances the formation of cross-linked rod micelles at lower surfactant concentrations thereby resulting in viscous solutions having long retention times on vertical surfaces. Phosphonate based Belsperse 164 acts as a dispersing agent and also functions in scale removal. The final formulations may be of gel type, or foam type, or other type.

The invention provides a relatively simple method for manufacturing the stable and efficient biocide composition. Essentially, strongly alkali sulfamated hypobromite with surfactant(s) according to the invention will ideally serve as cleaning, antibiofouling, and disinfecting composition in meat production lines. Several components are mixed, each of which seems to have its role both in the active halogen stabilization and in the superior cleaning and disinfecting activity of the mixture. The components, hypobromite, sulfamate, hydroxide, sodium chloride, and surfactant may be obtained separately and mixed, but advantageously sodium hypobromite with sodium sulfamate and sodium chloride will be obtained as described in WO 03/093171, authored by some of the present inventors, and then will be simply mixed with sodium hydroxide and surfactant(s). The surfactant(s) comprises at least one surface active agent compatible with alkali pH and with strongly oxidative environment, usually up to six different agents are included, for example one or two or three or four or five or six agents, their total concentration being between 4% and 12%. In one preferred embodiment, the surfactants comprise biodegradable materials. In some embodiments, the surfactants comprise polyacrylate-based agents, polyacrylic-hypophosphite based agents, alkylsulfonates, alkyl-aryl-suphonates, alkylamine oxides, alkylethylene oxide sulfonates, etc. In one preferred embodiment, the surfactant comprises an anionic polymeric dispersant. The composition for prolonged storage may have a concentration of active bromine of more than 100,000 ppm, usually more than 10,000 ppm. The concentrations will be much lower in many of the applications. An example of a concentrated biocide (stock) composition according to the invention includes up to 10% sodium hypobromite and slightly more (by several wt % based on hypobromite weight) sodium sulfamate, at least 10% sodium hydroxide, about 10% surfactant, and about 2 w % sodium chloride.

The aqueous biocide of the invention enables superior treatment of hard surfaces in the meat industry environment. However, the biocide may be also advantageously employed for treating large meat blocks or animal carcasses, as well as storage and package containers for food, tools, and equipment. Meat industry, as used in this text, means industry aiming at providing, producing and processing any meat and any meat products, including meat, poultry, and fish of any kind, the processing may include any step from transporting the animals till packaging and storing the final products.

The invention will be further described and illustrated by the following examples.

### EXAMPLES

### Example 1

The following formulations were prepared: the comparative formulation corresponds to a commercial cleaning biocidal composition and contains active halogen as a hypochlorite solution. The formulation according to the invention comprises the same molar concentration of active halogen as the comparative formulation, but in the form of a hypobromite solution. The sulfamated hypobromite solution (Bromine Compounds Ltd.) was prepared as described in WO 03/093171.

Comparative Formulation 1:

| Distilled water | 20.8 g | |
|---|---|---|
| Sodium hydroxide (50%) | 31.0 g | 15.5% |
| Cambrex N45* | 08.0 g | 8.0% |
| Sodium hypochlorite (10.2% active Cl₂) | 40.2 g | 4.1% |
| Total | 100 g | |
| Active halogen expressed as Cl₂ | | 4.1% |

*Anionic polymeric dispersant of Cambrian Solutions Inc.

Formulation 1:

| Distilled water | 13.73 g | |
|---|---|---|
| Sodium hydroxide (50%) | 22.93 g | 11.47% |
| Cambrex N45 | 08.00 g | 8.0% |
| Stabilized hypobromite*(7.42% | 55.34 g | 4.1%** |
| active Cl₂ = 16.7% active Br₂) | | |
| Total | 100 g | |
| Active halogen as Cl₂ | | 4.1% |

*~12.5% NaOBr, ~15% sodium sulfamate, ~1.2% NaOH, ~4% NaCl
**Active halogen expressed as active Br₂ is 2.25 times higher, i.e. 9.2%.

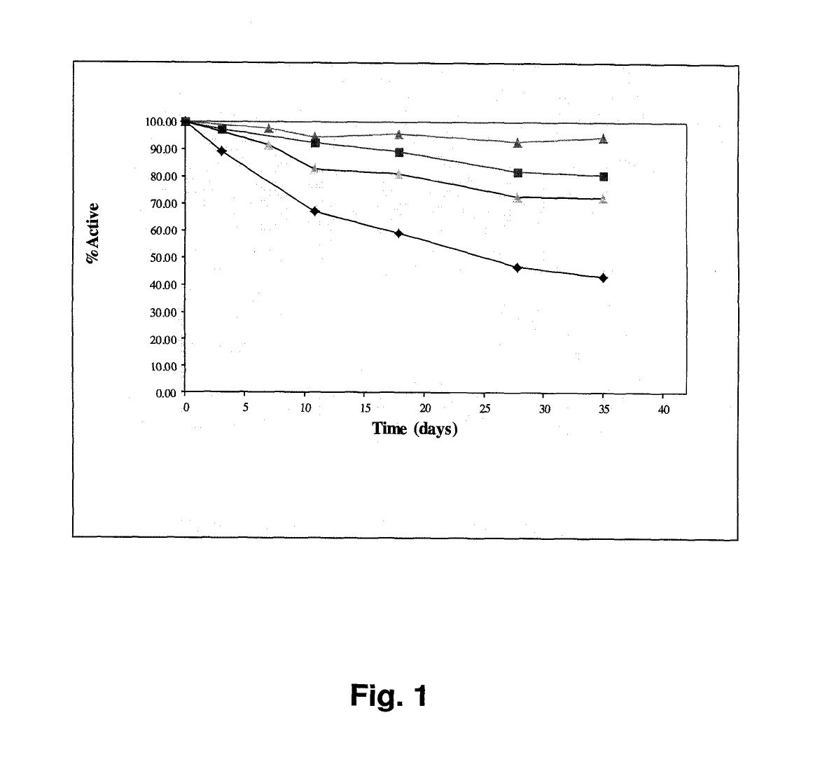

The concentrations of the active halogen in the formulations stored at 25° C. and 35° C. were measured by iodometric titration during 35 days (FIG. 1). It can be seem that the biocidal formulation according to the invention has much better storage stability than the comparative commercial formulation: the active halogen in the former formulation decreased to about 92% (the uppermost curve in FIG. 1) and 80% of the initial value (the second curve below), at 25° C. and 35° C., respectively; the active halogen in the latter formulation decreased to about 71% (the third curve below) and 43% (the fourth curve below) of the initial value, at 25° C. and 35° C., respectively. If supposing that the decrease of the active halogen in the formulations is a first order reaction, the half-life τ_{1/2} of the active halogen may be assessed from the equation:

τ_{1/2}=t ln 2/ln(A₀/Aₜ)

wherein A₀ and Aₜ are concentrations of the active halogen at times 0 and t, respectively. The decreases of active halogen to 92%, 80%, 71%, and 43% of the initial value thus provide the hall-life values of 291 days, 109 days, 71 days, and 29 days respectively. The biocidal formulation according to the invention will keep 50% of its initial active halogen when stored at ambient temperature (25° C.) for 291 days, which is four times longer than in case of the comparative example. The above formula will also enable to a skilled person to estimate the maximal storage time for a desired maximal loss: for example a maximal loss of 10, 20, or 30% will comprise storage at ambient temperature for 44, 94, and 150 days, respectively. Conversely, if the initial active bromine is 13.5% and the final acceptable active bromine is 5% for certain application, the formula provides the maximal storage time of 417 days at room temperature, or 834 days at 15° C. The instant composition is relatively very stable, when compared with the half-lives of hours or days of various prior art compositions.

In conclusion, the half-life at ambient temperature of the active halogen in Formulation 1 was 291 days, whereas the half-life at ambient temperature of the active halogen in Comparative Formulation 1 was 71 days. Formulation 1, at needed dilutions, will be an efficient cleaning composition in meat industry applications, for example in CIP systems.

### Example 2

The following formulations were prepared. The comparative formulation corresponds to a commercial cleaning and biocidal composition and contains active halogen as a hypochlorite solution. The formulation according to the invention comprises the same molar concentration of active halogen as the comparative formulation, but in the form of a hypobromite solution. The sulfamated hypobromite solution (Bromine Compounds. Ltd.) was prepared as described in WO 03/093171.

Comparative Formulation 2:

| | | |
|---|---|---|
| Distilled water | 47.8 g | |
| Sodium hydroxide (50%) | 11.1 g | 5.55% |
| Sodium xylene sulfonate (40%) | 2.4 g | 0.96% |
| Biosoft S101 (Dodecyl benzene sulfonic acid) | 0.9 g | 0.9% |
| Emery 658 (caprylic-capric fatty acid) | 2.1 g | 2.1% |
| Cedepal TD 403 (sodium tridecyl ether sulfate, 30%) | 0.6 g | 0.18% |
| Belsperse 164 (phosphono carboxylic acid, 40%) | 1 g | 0.4% |
| Aromox ® 14D-W970 (tetradecyl dimethyl amine | 7.4 g | 1.85% |
| oxide, 25%) | | |
| Sodium hypochlorite (10.1% active Cl₂) | 26.8 g | 2.71% |
| Active halogen expressed as Cl2 | | 2.7% |
| Total | 100 g | |

Formulation 2:

| | | |
|---|---|---|
| Distilled water | 37.5 g | |
| Sodium hydroxide (50%) | 11.5 g | 5.76% |
| Sodium xylene sulfonate (40%) | 2.4 g | 0.96% |
| Biosoft S101 (Dodecyl benzene sulfonic acid) | 0.9 g | 0.9% |
| Emery 658 (caprylic-capric fatty acid) | 2.1 g | 2.1% |
| Cedepal TD 403 (sodium tridecyl ether sulfate, 30%) | 0.6 g | 0.18% |
| Belsperse 164 (phosphono carboxylic acid, 40%) | 1 g | 0.4% |
| Aromox ® 14D-W970 (tetradecyl dimethyl amine | 7.3 g | 1.85% |
| oxide, 25%) | | |
| Stabilized hypobromite (7.42% active Cl₂ = 16.7% | 36.7 g | 2.72% |
| active Br₂) | | |
| Active halogen expressed as Cl2 | | 2.7% |
| Total | 100 g | |

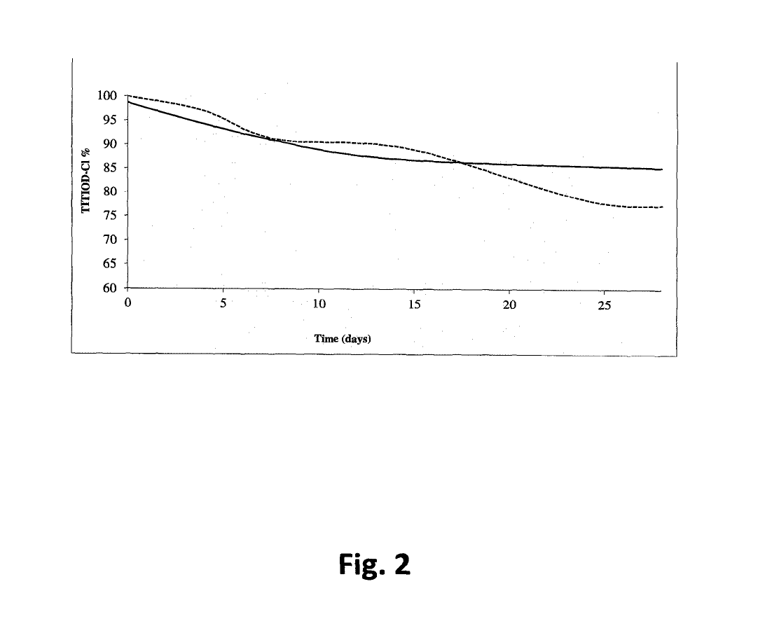

The concentration of the active halogen in the formulations stored at 35° C. was measured by iodometric titration during 30 days (FIG. 2). It can be seem that the biocidal formulation according to the invention had better storage stability than the comparative commercial formulation: the active halogen in the former formulation decreased to about 85% (the upper curve in FIG. 2), while the active halogen in the latter formulation decreased to about 78% (the lower curve) of the initial value. The half-life values τ_{1/2} of the active halogen in the formulations at 35° C., when calculated according to the equation presented in Example 1 above, would be 119 days and 77 days, respectively; the τ_{1/2} values for ambient temperature (about 25° C.) would be approximately double, namely 238 and 154 days, respectively.

In conclusion, the half-life at ambient temperature of the active halogen in Formulation 2 was 238 days, whereas the half-life at ambient temperature of the active halogen in Comparative Formulation 2 was 154 days. Formulation 2, at needed dilutions, will be an efficient cleaning composition in meat industry applications, for example in OPC systems.

### Example 3

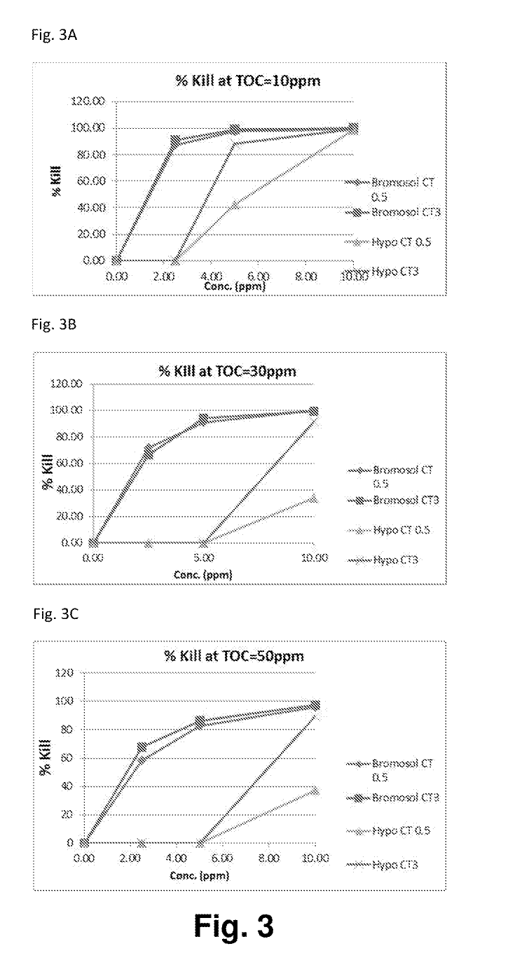

Biocidal tests were carried with bacteria from sludge taken from a waste water treatment plant (Haifa). The results are shown in FIG. 3 and in Tab. 1 to Tab. 3.

TABLE 1
Bacteria kill at TOC = 10

| Active halogen | Bromine | Bromine | Chlorine | Chlorine |
|---|---|---|---|---|
| (ppm) | CT 0.5 hr | CT 3 hr | CT 0.5 | CT 3 hr |
| 0.00 | 0.00 | 0.00 | 0.00 | 0.00 |
| 2.50 | 87.08 | 91.06 | 0.00 | 0.00 |
| 5.00 | 97.79 | 98.86 | 42.59 | 88.15 |
| 10.00 | 99.53 | 99.64 | 98.99 | 99.37 |

TABLE 2
Bacteria kill at TOC = 30

| Active halogen | Bromine | Bromine | Chlorine | Chlorine |
|---|---|---|---|---|
| (ppm) | CT 0.5 hr | CT 3 hr | CT 0.5 | CT 3 hr |
| 0.00 | 0.00 | 0.00 | 0.00 | 0.00 |
| 2.50 | 72.22 | 66.67 | 0.00 | 0.00 |
| 5.00 | 90.83 | 94.03 | 0.00 | 0.00 |
| 10.00 | 99.84 | 99.11 | 34.26 | 91.20 |

TABLE 3
Bacteria kill at TOC = 50

| Active halogen | Bromine | Bromine | Chlorine | Chlorine |
|---|---|---|---|---|
| (ppm) | CT 0.5 hr | CT 3 hr | CT 0.5 | CT 3 hr |
| 0 | 0.00 | 0.00 | 0.00 | 0.00 |
| 2.5 | 58.33 | 67.50 | 0.00 | 0.00 |
| 5 | 82.78 | 86.11 | 0.00 | 0.00 |
| 10 | 95.83 | 97.35 | 37.04 | 89.95 |

Formulation 1 and Comparative Formulation 1, as described in Example 1, were employed in bacterial suspensions comprising TOC (total organic carbon) of 10, 30, and 50, at pH 9 (carbonate buffer). Active halogen concentrations of 0 ppm, 2.5 ppm, 5 ppm, and 10 ppm were employed; contact times (CT) of 0.5 and 3 hours were employed. The results showed that the bromine-based formulation exhibited better biocidal efficacy for all three TOC levels.

While the invention has been described using some specific examples, many modifications and variations are possible. It is therefore understood that the invention is not intended to be limited in any way, other than by the scope of the appended claims.

1. A composition for cleaning hard surfaces from proteinaceous and fat residues, comprising stabilized active bromine and a surface active agent, where said stabilized active bromine has a half-life at ambient temperature of at least six months.

2. The composition of claim 1, comprising active bromine at a concentration of up to 6% when expressed as active chlorine, sulfamate as a stabilizer of said active bromine, and up to six surfactants.

3. The composition of claim 1, comprising
i) sodium hypobromite (NaOBr) in an amount of up to 10%;
ii) sodium sulfamate (NaSO₃NH₂) in a weight excess of about 10% above the weight of said NaOBr;
iii) sodium hydroxide (NaOH) in an amount of from 5 to 20%;
iv) sodium chloride (NaCl) in an amount of from 1% to 4%; and
v) surfactants in an amount of 4% to 12%;
the composition being an aqueous, biocidal solution for cleaning hard surfaces in meat industry, stable on storage.

4. The composition of claim 1, being highly efficient in cleaning hard surfaces from proteinaceous and fat residues, exhibiting strong biocidal properties even after prolonged storage at ambient temperature, and exhibiting a content of active bromine of at least 50,000 ppm even after storage at ambient temperature for 6 months or more.

5. (canceled)

6. The composition of claim 1, wherein said surfactants comprise an anionic polymer dispersant.

7. The composition of claim 1, for use in cleaning and/or disinfecting surfaces in food industry and particularly in meat industry, or in treating liquids in contact with said surfaces, the composition keeping its biocidal efficiency against viruses, bacteria, and fungi even after prolonged storage, and being ready-to-use, after optional dilution.

8-9. (canceled)

10. A method of cleaning hard surfaces in meat industry, comprising
i) providing a cleaning solution according to claim 1, storing said solution and optionally diluting it with water;
ii) contacting said hard surface with said solution for a desired time;
iii) optionally mechanically treating said surface; and
iv) washing said surfaces with water or with said solution being optionally further diluted.

11. The method of claim 10, wherein said step of providing a biocidal solution comprises mixing NaSO₃NH₂, NaOH, NaCl, surfactants, a source of NaOBr, and water.

12. The method of claim 10, wherein said step of providing a biocidal solution comprises dissolution in water of a tablet comprising NaOBr, NaSO₃NH₂, NaOH, NaCl and surfactants.

13. The method of claim 10, wherein said surfaces comprise knives, cutters, saws, mixers, gloves, and aprons, vehicles, trolleys, machines, conveyor belts, tools, equipment or premises employed in raising and transporting animals, in slaughtering animals and processing the carcasses, and in processing and storing meat and meat products.

14-15. (canceled)

16. The method of claim 10, further comprising treating surfaces exposed to microbial contamination inside food industry premises, including carcasses, meat blocks, meat products, and packaging materials.

17. The method of claim 10, further comprising treating water before or after its use in washing said surfaces, comprising admixing to said water said biocidal solution.

18. (canceled)

19. The method of claim 10, comprising reducing contamination, preventing cross-contamination, and minimizing the danger of infection.

20-21. (canceled)

22. A method of cleaning hard surfaces contaminated with proteinaceous and/or fatty residues, including surfaces employed in industry or agriculture, surfaces in contact with waste waters, and surfaces employed in public health facilities, comprising
i) providing a cleaning solution according to claim 1, storing said solution and optionally diluting it with water;
ii) contacting said hard surface with said solution for a desired time;
iii) optionally mechanically treating said surface; and
iv) washing said surfaces with water or with said solution being optionally further diluted.

23. A process for manufacturing the composition of claim 1 for efficient cleaning hard surfaces in meat industry, stable on prolonged storage, comprising
i) providing an aqueous solution comprising NaOBr in an amount of from 1 to 10%, NaSO₃NH₂ in a weight excess over said NaOBr of about 10%, and NaCl in an amount of 1 to 4%;
ii) admixing to the solution of step i an amount of aqueous NaOH; and
iii) admixing to said the mixture of step ii an amount of surfactant comprising one or more different materials;
wherein said amounts of aqueous NaOH and of surfactant are such that the final NaOH concentration is between about 5 and about 20% and the final surfactant concentration is between 4 and 12%, and wherein said admixing steps are performed at ambient temperature or at a temperature lower than ambient.

24-25. (canceled)
